(19) United States
(12) Patent Application Publication
(10) Pub. No.: US 2013/0063504 A1
(43) Pub. Date: Mar. 14, 2013

(54) INKJET PRINTER AND INK CIRCULATION CONTROL METHOD

(71) Applicants: Megumi Shimizu, Saitama (JP); Isao Suzuki, Shizuoka (JP); Masaya Ichikawa, Shizuoka (JP)

(72) Inventors: Megumi Shimizu, Saitama (JP); Isao Suzuki, Shizuoka (JP); Masaya Ichikawa, Shizuoka (JP)

(73) Assignee: TOSHIBA TEC KABUSHIKI KAISHA, Tokyo (JP)

(21) Appl. No.: 13/603,546

(22) Filed: Sep. 5, 2012

(30) Foreign Application Priority Data
Sep. 8, 2011 (JP) 2011-196254

(51) Int. Cl. B41J 29/38

(52) U.S. Cl. 347/6; 347/17

(57) ABSTRACT

According to an exemplary embodiment, there is provided an inkjet printer which causes ink to flow in a circulation path communicating from an upstream ink tank to a downstream ink tank via an inkjet head, and is able to discharge the ink, wherein the inkjet printer includes an ink temperature measuring unit adapted to measure an ink temperature in the upstream ink tank and the downstream ink tank; an ink temperature adjustment portion adapted to gradually raise the ink temperature of the upstream ink tank and the downstream ink tank; a circulation control unit adapted to circulate ink filling the circulation path in a room temperature state for a planned time; and an ink temperature control unit adapted to raise the ink temperature of the upstream ink tank and the downstream ink tank up to a preset temperature while circulating the ink after the planned time elapses.

### CROSS-REFERENCE TO RELATED APPLICATION

This application is based upon and claims the benefit of priority from the prior Japanese Patent Application No. 2011-196254, filed on Sep. 8, 2011, the entire contents of which are incorporated herein by reference.

### FIELD

Embodiments described herein relate generally to an inkjet printer which causes ink to flow in a circulation path and is able to discharge ink from nozzles of an inkjet head, and an ink circulation control method.

### BACKGROUND

From the related art, an inkjet printer is known which has an inkjet head and an ink circulation mechanism, and is able to discharge ink from nozzles of the inkjet head, while circulating ink via the inkjet head. In such an inkjet printer, upstream and downstream side ink tanks and an inkjet head (also called a print head) are included, ink is circulated between the upstream and downstream side ink tanks and the print head, and ink is discharged from the nozzles of the print head to perform printing and recording.

In such an inkjet printer, if high viscosity ink is discharged, there is a need to supply ink to the head by raising the ink temperature and lowering the viscosity of ink in advance. Furthermore, there is a need to lower the temperature if low viscosity ink is used. That is, generally, since a UV ink and a functional ink have high viscosity at normal temperature, the viscosity of such inks is greater than the viscosity region usable by the inkjet head, and it is difficult to discharge ink as it is.

However, if the ink temperature is raised, the temperature (viscosity) of ink in the circulation path is greatly changed from the beginning of circulation of ink until the ink circulation is stable. At this time, there are problems occurring in which ink drips from the nozzles and air is sucked in.

According to a first aspect of an exemplary embodiment, there are provided an inkjet printer and an ink circulation control method capable of circulating and supplying ink without causing defects in which ink drips from the nozzles or air is sucked in from the beginning of circulation of ink to the stable circulation state.

### BRIEF DESCRIPTION OF THE DRAWINGS

FIG. 1 is a configuration diagram that illustrates an ink circulation portion of an inkjet printer according to an embodiment.

FIG. 2 is a block diagram that illustrates a control device portion of the inkjet printer according to the embodiment.

FIG. 3 is a circuit diagram that illustrates the ink circulation portion of the printer according to the embodiment by simulating an electric circuit.

FIG. 4 is a configuration diagram that illustrates an ink circulation portion of an inkjet printer according to another embodiment.

FIG. 5 is a block diagram that illustrates a control device portion of the inkjet printer according to another embodiment.

FIG. 6 is a graph that describes a change in ink temperature in an inkjet head portion of an inkjet printer according to another embodiment.

FIG. 7 is a flowchart that describes an operation of the inkjet printer according to another embodiment.

### DETAILED DESCRIPTION

According to an exemplary embodiment, there is provided an inkjet printer which causes ink to flow in a circulation path communicating from a downstream ink tank to an upstream ink tank, from the upstream ink tank to the downstream ink tank via an inkjet head, and is able to discharge ink from nozzles of the inkjet head, wherein the inkjet printer includes an ink temperature measuring unit adapted to measure the ink temperature in the upstream ink tank and the downstream ink tank; an ink temperature adjustment portion adapted to gradually raise the ink temperature of the upstream ink tank and the downstream ink tank; a circulation control unit adapted to circulate ink filling the circulation path in a room temperature state for a planned time; and an ink temperature control unit adapted to operate the ink temperature adjustment portion while circulating the ink after the planned time elapses, and raise the ink temperature of the upstream ink tank and the downstream ink tank up to a preset temperature.

Hereinafter, an embodiment of a paper transport device will be described with reference to the drawings.

Hereinafter, an exemplary embodiment will be described in detail using the drawings.

### First Embodiment

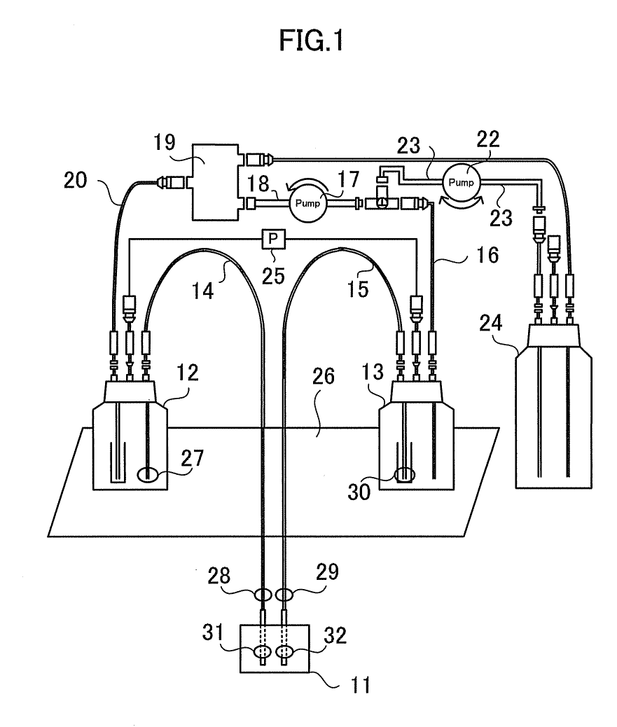

FIG. 1 illustrates an inkjet device portion of a printer including an inkjet head 11 in the present embodiment. Although the detailed configuration is not shown, the inkjet head 11 has a configuration that is described in JP-A-2009-66866. The inkjet head 11 has a plurality of flow paths through which the head is circulated, thin-film-shaped drive electrodes are each provided on inner surfaces of the respective flow paths, and ink discharge ports (hereinafter, referred to as nozzles) are provided corresponding to the flow paths. Moreover, ink droplets are discharged from the nozzles by applying an electric field to the drive electrodes.

An upstream ink tank 12 and a downstream ink tank 13 are connected to the inkjet head 11 via conduit line members 14 and 15. The downstream ink tank 13 is connected to a suction side of a circulation pump 17 via a conduit line member 16, and a discharge side of the circulation pump 17 is connected to the upstream ink tank 12 sequentially via a conduit line member 18, a filter 19 and a conduit line member 20. The conduit line members 14 and 15 mentioned above communicate with the flow path mentioned above of the inkjet head 11, and constitute a circulation path of ink together with the flow path. Thus, the inkjet head 11 discharges ink flowing through the circulation path from the nozzles correspondingly provided for each flow path, by operating the thin-film-shaped drive electrode provided on the inner surface of the flow path.

A conduit line member 23 having an ink supply pump 22 is connected to the conduit line member 16 constituting the ink circulation path, and the conduit line member 16 communicates with an ink supply tank 24 by the conduit line member 23. The ink supply pump 22 supplies ink in the ink supply tank 24 to the ink circulation path by a normal rotation, and returns ink from the ink circulation path to the ink supply tank 24 by a reverse rotation.

Furthermore, the upstream ink tank 12 and the downstream ink tank 13 are provided with pressure gauges 25, and the pressure signal measured thereby controls the ink supply pump 22 and adjusts the pressure of the upstream ink tank 12 and the downstream ink tank 13.

In addition, the upstream ink tank 12 and the downstream ink tank 13 are provided with an ink temperature adjustment portion 26 that gradually raises the ink temperature. The ink temperature adjustment portion 26 is a so-called water bath structure in which liquid is accommodated in a container, and the upstream ink tank 12 and the downstream ink tank 13 are immersed in the liquid. Moreover, the liquid is heated by an electric heater (not shown), and ink in the upstream ink tank 12 and the downstream ink tank 13 is heated via the liquid. That is, the ink temperature adjustment portion 26 does not heat the ink tanks 12 and 13 by injecting a boiling high-temperature liquid into the container but heats the ink tanks 12 and 13 along with a temperature rise of the liquid by heating the liquid in the container from the normal temperature. Thus, it is possible to gradually raise the ink temperature in the ink tanks 12 and 13.

Furthermore, in the upstream ink tank 12, the downstream ink tank 13, the upstream side conduit line member 14 and the downstream side conduit line member 15 near the inkjet head, thermocouples 27, 28, 29 and 30 as temperature measurement units are each provided. Furthermore, thermistors 31 and 32 as temperature measurement units are also provided at the upstream side and the downstream side in the inkjet head 11. The temperature measurement units 27 to 32 detect the temperature of ink that flows in the upstream side conduit line member 14 and the downstream side conduit line member 15 of the circulation path and an inkjet head 11.

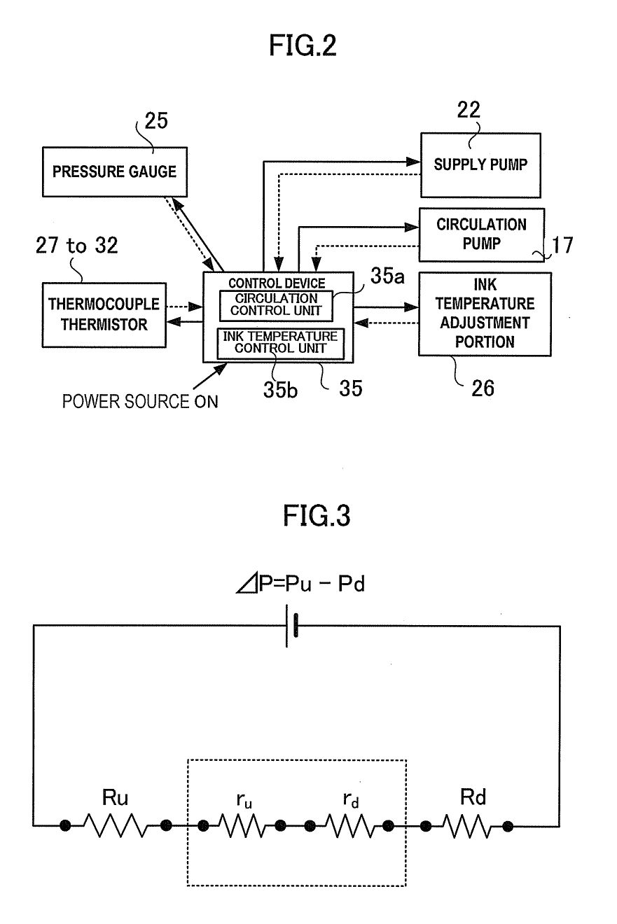

The temperature measurement units 27 to 32 and the pressure gauge 25 mentioned above are connected to a control device 35 using a computer or the like as shown in FIG. 2, and the detection signal is input to the control device 35. Furthermore, the control device 35 is also connected to the circulation pump 17, the supply pump 22 and the ink temperature adjustment portion 26 shown in FIG. 1 and controls such apparatuses based on the pressure detection signal and the temperature detection signal mentioned above.

That is, the control device 35 has a circulation control unit 35a and an ink temperature control unit 35b. The circulation control unit 35a circulates ink filling the circulation path mentioned above by the circulation pump 17 as the room state for a planned time. After the planned time elapses, the ink temperature control unit 35b operates the ink temperature adjustment portion 26 while circulating the ink, and raises the ink temperature in the upstream ink tank 12 and the downstream ink tank 13 up to a preset temperature.

In the circulation path mentioned above, if a pressure difference between the upstream ink tank 12 and the downstream ink tank 13 is constant, the sum of the product of the flow rate and the flow path resistance from the upstream ink tank 12 to the inkjet head 11 and the downstream ink tank 13 is equal to an energy difference between the upstream ink tank 12 and the downstream ink tank 13. Herein, if energy of the upstream ink tank 12 is Pu, energy of the downstream ink tank 13 is Pd, a flow path resistance of the conduit line member 14 at the upstream side is Ru, a flow path resistance in the inkjet head 11 at the same upstream side is ru, a flow path resistance of the conduit line member 14 at the downstream side is Rd, and a flow path resistance in the inkjet head at the same downstream side is rd, they can be schematically show using an electric circuit diagram as shown in FIG. 3. A corresponding relationship between each element of the electric circuit of FIG. 3 and each portion shown in FIG. 1 is indicated as below.

Potential difference: V [V]

Energy difference: ΔP [Pa]

Current: I [A]

Flow rate: Q [m³/s]

Resistance: R [V/I]

Flow path resistance: R [Pa·s/m³]

The relationship in the circulation path is indicated as below in response to Ohm's law in the electric circuit.

ΔP=Pu−Pd

ΔP=(Ru+ru) Q+(Rd+rd) Q

At this time, when the energy loss in the upstream side is identical to that in the downstream side as in Formula (1) as below, the nozzle pressure of the inkjet head 11 becomes a suitable predetermined pressure (a slightly negative pressure).

(Ru+ru) Q=(Rd+rd) Q (1)

However, when the flow path resistance is changed due to the temperature change in the ink circulation path, generally, the energy loss in the upstream side is equal to that in the downstream side as a formula as below.

(Ru+ru) Q≠(Rd+rd) Q

In order to solve the problem, by changing the flow path resistances Ru and Rd like a variable resistance, the control maybe performed so that Formula (1) is satisfied. That is, the control may be performed so that a flow path resistance ratio is Ru:Rd=1:1.

Herein, the flow path resistances Ru and Rd can be solved as below.

A flow path resistance R of a circular tube can be solved by a basic, formula (2) as below.

$$\begin{matrix}[ Formula 1 ] & \\ R = \frac{128}{π {d}^{4}} L μ & ( 2 )\end{matrix}$$

That is, the flow path resistance can be solved from Formula 2 mentioned above from a diameter of the circular tube d [m], a length of the circular tube L [m], and viscosity of fluid (ink) flowing through the circular tube μ [Pa·sec]. Thus, the flow path resistance per unit length is indicated in Formula (3) as below.

$$\begin{matrix}[ Formula 2 ] & \\ ( \frac{d R}{d L} = ) \frac{R}{L} = \frac{128}{π {d}^{4}} μ & ( 3 )\end{matrix}$$

If the viscosity μ indicates temperature dependence, a relationship between the viscosity and the temperature T is indicated by Formula (4) as below.

μ=μ (T) (4)

In addition, if the temperature can be expressed using the length L of the circular tube, the relationship is indicated by Formula (5) as below.

μ=μ(T(L)) (5)

Herein, the temperature dependence of the viscosity is expressed by Formula (6) as below assuming an Arrhenius type.

$$\begin{matrix}[ Formula 3 ] & \\ μ = α exp ( \frac{β}{T} ) & ( 6 )\end{matrix}$$

In addition, α and β depend on properties of matter of ink.

Furthermore, supposing that the temperature T is proportional to the length L of the circular tube, Formula (7) is obtained as below.

T=aL+b (7)

If substituting such a relationship for Formula (3), Formula (8) is obtained as below.

$$\begin{matrix} [ Formula 4 ] & \\ \frac{d R}{d L} = \frac{128}{π {d}^{4}} \{ μ + L \frac{d μ}{d T} \frac{d T}{d L} \} = \frac{128}{π {d}^{4}} \{ μ + L ( - \frac{αβ}{{T}^{2}} ) exp ( \frac{β}{T} ) a \} = \frac{128}{π {d}^{4}} μ \{ 1 + L ( - \frac{a β}{{T}^{2}} ) \} & ( 8 )\end{matrix}$$

If integrating Formula (8), Formula (9) is obtained as below.

$$\begin{matrix} [ Formula 5 ] & \\ R = \int d L \frac{128}{π {d}^{4}} μ \{ 1 + L ( - \frac{a β}{{T}^{2}} ) \} = \frac{128}{π {d}^{4}} α \int d L exp ( \frac{β}{aL + b} ) \{ 1 + L ( - \frac{a β}{{T}^{2}} ) \} & ( 9 )\end{matrix}$$

Since the function mentioned above is difficult in an elementary integral, the function is acquired by Formula (10) as below using measuration by division.

$$\begin{matrix}[ Formula 6 ] & \\ R = \frac{128}{π {d}^{4}} α {\sum }_{i = 1}^{n} Δ {L}_{i} exp ( \frac{β}{a {L}_{i} + b} ) \{ 1 + {L}_{i} ( - \frac{a β}{{T}^{2}} ) \} & ( 10 )\end{matrix}$$

In addition, if another circular tube is connected as a conduit line member, the flow path resistance of each circular tube is Rj (j=1, 2, . . . , N), and the sum of each flow path resistance is acquired by Formula (11) as below.

$$\begin{matrix} [ Formula 7 ] & \\ R = {\sum }_{j = 1}^{N} {R}_{j} = {\sum }_{j = 1}^{N} \frac{128}{π {d}_{j}^{4}} α {\sum }_{i = 1}^{n} Δ {L}_{i} exp ( \frac{β}{{aL}_{ij} + b} ) \{ 1 + {L}_{ij} ( - \frac{a β}{{T}^{2}} ) \} & ( 11 )\end{matrix}$$

However, a subscript j indicates the kind of each circular tube, and a subscript i indicates a part that is considered to be divided from the circular tube.

From the relationship mentioned above, in order to perform the control so that the flow path resistance ratio Ru:Rd is nearly 1:1, from Formula (2), if the length L of the circular tube and the diameter d of the circular tube serving as the upstream side and downstream side conduit lines 14 and 15 are not changed, a change in ink viscosity (μ) in the upstream and downstream ink circulation paths, that is, as indicated by Formula (6), a change in temperature T in the ink circulation path may be gentle as possible.

Thus, the ink circulation path shown in FIG. 1 is constituted. Firstly, the ink supply pump 22 is driven to fill the upstream ink tank 12 with ink by the ink supply tank 24 via the filter 19. After that, the head 11 is filled with ink, and the downstream ink tank 13 is filled with ink. In this manner, after the circulation path is filled with ink, the circulation pump 17 is driven, the ink is circulated in the circulation path at room temperature. At this time, a foreign body removal in ink and an air bubble removal in ink are performed by the filter 19.

From the circulation beginning to the circulation stability (the temperature of the head 11 reaches a necessary area), the control is performed by a sequence described as below. Such a control can make the temperature change in the ink circulation path gentle and thus is the best.

That is, as mentioned above, the circulation pump 17 is driven, and (a.) the ink circulation is performed for a while at a room temperature (about five minutes). After that, (b.) the upstream side ink tank 12 and the downstream side ink tank 13 are gradually heated by the ink temperature adjustment portion 26 of a water bath structure. In this case, the ink temperature in the ink tanks 12 and 13 are gradually raised by heating liquid in the container of the ink temperature adjustment portion 26 of the water bath structure using a heating heater (not shown). The ink temperature (the detection temperatures of the thermocouples 27 and 30) is almost equal to the head temperature (the detection temperatures of the thermistors 31 and 32) by the control.

In addition, the detailed condition of the control can be acquired by investigating the temperature characteristics of the thermocouples 27 and 30 and the thermistors 31 and 32.

Hereinafter, an overall control operation will be described based on FIG. 2. In FIG. 2, if a device power source on-signal is input to the control device 35, the control device 35 operates the supply pump 22 and supplies ink from the ink supply tank 24 to the ink circulation path. After a constant time elapses, when ink is filling the ink circulation path, the ink supply pump 22 sends the signal to the control device. The control device 35 stops the ink supply pump 22.

Next, the control device 35 operates the circulation pump 17. After a constant time (about five minutes) elapses, the control device 35 operates the ink temperature adjustment portion 26, and gradually raises the ink temperature in the ink tanks 12 and 13. At this time, the control device 35 controls the ink temperature adjustment portion 26 depending on the detection temperature of the thermistors 31 and 32 and the thermocouples 27 and 30. Furthermore, the control device 35 controls the supply pump 22 depending on the detection value of the pressure gauge 25 and keeps the ink circulation path in the pressure relationship mentioned above.

It is possible to reduce the change in temperature T in the circulation path of ink from the circulation beginning to the circulation stability by such a control. As a consequence, it is possible to prevent defect that ink hangs down from the nozzles and air is sucked.

### Configuration of Another Embodiment

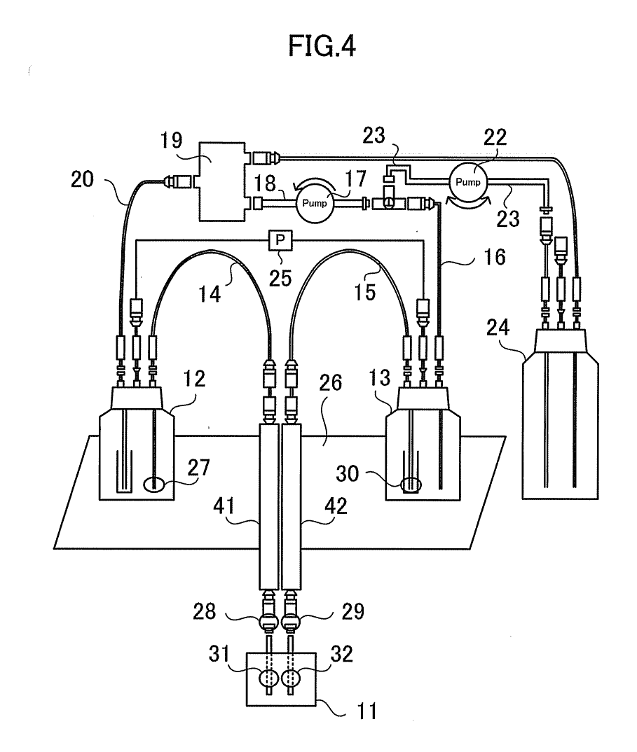

Next, another embodiment will be described. As shown in FIG. 4, in the present embodiment, heating portions 41 and 42 using tube heaters are each provided in the upstream side conduit line member 14 from the upstream ink tank 12 to the inkjet head 11 and the downstream side conduit line member 15 from the inkjet head 11 to the downstream ink tank 13 of the circulation path to heat ink flowing therethrough. The heating portions 41 and 42 are provided in portions of the upstream side conduit line member 14 and the downstream side conduit line member 15 closest to the inkjet head 11.

As shown in FIG. 5, the heating portions 41 and 42 are connected to the control device 35 and the temperature thereof is controlled by a heating portion control unit 35c provided in the control device 35. When the ink temperature of the upstream ink tank 12 and the downstream ink tank 13 reaches a predetermined temperature, the heating portion control unit 35c operates the heating portions 41 and 42, and raises the temperature in the inkjet head 11 to a predetermined temperature. That is, the heating portion control unit 35c controls the heating portions 41 and 42 so that the ink temperature in the inkjet head 11 becomes substantially the same as the ink temperature in the upstream ink tank and the downstream ink tank.

Other configurations are the same as those of FIGS. 1 and 2. The present embodiment has a configuration coping with when the ink tanks 12 and 13 including the ink temperature adjustment portion 26 cannot be placed near the inkjet head 11, the upstream side and downstream side conduit line members 14 and 15 are lengthened, and the ink temperature in the conduit line members 14 and 15 is changed due to heat radiation, or when a temperature difference between the ink temperature in the ink tanks 12 and 13 and the head 11 is greatly increased.

In the present embodiment, even in the configuration as mentioned above, a configuration of an ink circulation system is adopted in which the lengths L of the circular tubes serving as the upstream side and downstream side conduit lines 14 and 15 and the diameters d of the circular tube are the same so that the flow path resistance ratio Ru:Rd is substantially 1:1, and the heating portions 41 and 42 using the tube heater are added near the inkjet head 11 so that a change in ink viscosity (μ) in the upstream and downstream ink circulation paths, that is, a change in temperature T in the ink circulation path becomes gentle as possible.

In addition, the upstream ink tank 12, the downstream ink tank 13, the ink temperature adjustment portion 26 of the water bath structure, the ink supply tank 24, the supply pump 22, the circulation pump 17, the filter 19, the pressure gauge 25, the temperature measurement units (the thermocouples 27, 28, 29 and 30 and the thermistors 31 and 32) are included as in FIG. 1.

Herein, for example, if the high-viscosity ink is discharged, there is a need to raise the ink temperature in advance (lower the ink viscosity) and supply ink to the head 11. However, if the ink temperature is too raised, the ink characteristics are degraded (drying, pigment cohesion and sedimentation, instability of the dispersion or the like), and thus, the ink temperature is limited to a range in which the ink characteristics are not degraded. At this time, ink in the upstream ink tank 12 and the downstream side ink tank 13 are sufficiently heated and circulated by the temperature adjustment portion 26 of the water bath structure. However, if the ink circulation is performed without using the heating portions 41 and 42 using the tube heaters, the temperature difference between the upstream side thermistor 31 and the downstream side thermistor 32 of the print head 11 in the circulation beginning is increased, and there is a problem that ink hangs down from the nozzles of the head 11. Furthermore, at this time, the temperature difference among the ink temperature (the thermocouple 27) of the upstream ink tank 12, the upstream ink temperature (the thermocouple 28) of the print head 11, and the upstream thermistor 31 of the print head 11 is also increased. Furthermore, in order to make the print head 11 the temperature of the necessary area, the temperature (the thermocouple 27) of the upstream ink tank 12, that is, the ink temperature needs to be greatly raised, and thus, there is also a problem that the ink characteristics are degraded as mentioned above.

Thus, the ink circulation path as shown in FIG. 4 is constituted. Even if the high-viscosity ink is circulated, the control is performed from the circulation beginning to the circulation stability, that is, until the head temperature reaches the necessary area in a sequence mentioned below, and the temperature change in the ink circulation path is gentle.

That is, the circulation pump 17 is driven, (a.) the ink circulation is performed for a while (about five minutes) at a room temperature, and then, (b.) the upstream side ink tank 12 and the downstream side ink tank 13 are gradually heated by the ink temperature adjustment portion 26 of the water bath structure. At this time, the upper limit temperature of the ink adjustment portion 26 is within a range that does not degrade the ink characteristics as mentioned above. After that, immediately, (c.) the heating portions 41 and 42 using the upstream side and downstream side tube heaters are driven to heat ink in the tube.

In addition, the heating portion 42 using the tube heater of the downstream side (the downstream side tube heater) can be heated earlier than the heating portion 41 using the tube heater of the upstream side (the upstream side tube heater). In this manner, when heating the heating portion 42 earlier than the heating portion 41, it is possible to rapidly heat ink flowing in the downstream side conduit line member 15, and thus it is possible to shorten the time until ink in the conduit line members 14 and 15 become the same temperature.

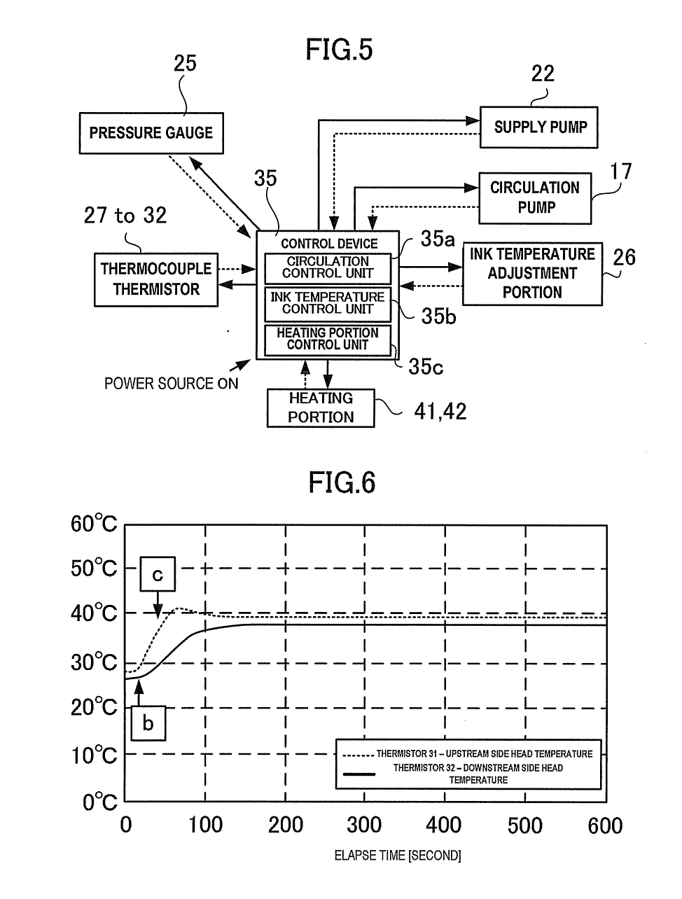

FIG. 6 illustrates a temperature example of the thermisotrs 31 and 32 from the circulation beginning to the circulation stability mentioned above. Herein, the temperature characteristics from the ink heating beginning using the ink temperature adjustment portion 26 in (b.) mentioned above are shown, and the temperature characteristics during ink circulation at a room temperature in (a.) mentioned above are omitted. That is, in FIG. 6, the heating using the ink temperature adjustment portion 26 is started in a b point, and the heating using the heating portions 41 and 42 is performed in a c point. After such an operation, the difference between the thermistors 31 and 32 is reduced, the circulation is stable (the head temperature reaches the necessary area).

### Operation Description of Embodiment

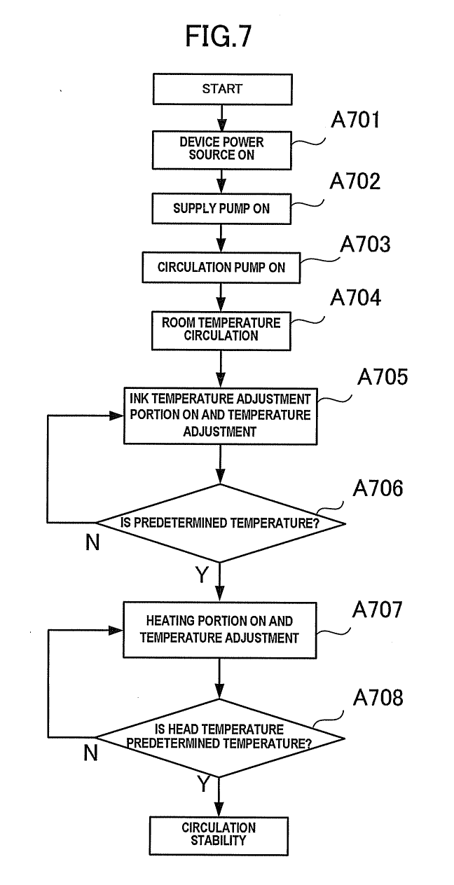

Hereinafter, an overall operation will be described using FIG. 5 and a flow chart of FIG. 7. When the power source device on-signal is input to the control device 35 (A701), the control device 35 operates the supply pump 22 (A702). After a constant time elapses, when ink is filling the ink circulation path, the ink supply pump 22 sends the signal to the control device 35, and the control device 35 stops the supply pump 22.

Next, the control device 35 operates the circulation pump 17 using the circulation control unit 35a (A703) and circulates ink at a room temperature (A704). After a preset time elapses (about five minutes), the ink temperature adjustment portion 26 is operated by the ink temperature control unit 35b (A705), and the ink temperature is gradually raised.

In the process, it is confirmed whether or not the ink temperature reaches a predetermined temperature (A706), and the heating portions 41 and 42 are operated using the heating portion control unit 35c (A707). At this time, the control device 35 controls the ink temperature adjustment portion 26 and the heating portions 41 and 42 depending on the measurement temperature of the thermistors 31 and 32 and the thermocouples 27, 28, 29 and 30. Furthermore, the control device 35 controls the supply pump 22 depending on the detection value of the pressure gauge 25 and keeps the ink circulation path in the pressure relationship mentioned above.

The temperature change in the circulation path of ink can be reduced from the circulation beginning to the circulation stability through such a control. As a consequence, it is possible to prevent defect that ink hangs down from the nozzles and air is sucked.

In the embodiment mentioned above, as shown in FIGS. 1 and 4, a situation is described in which the upstream ink tank 12 and the downstream ink tank 13 are immersed in one ink temperature adjustment portion 26. However, such an ink tank may enter another ink temperature adjustment portion. That is, the upstream ink tank 12 may be immersed in one ink temperature adjustment portion, and the downstream ink tank 13 maybe immersed in another ink temperature adjustment portion.

In this manner, in the respective embodiments mentioned above, ink can be circulated and supplied between the circulation beginning state to the stable circulation state of the circulation type inkjet head adapted to discharge ink from the nozzles of the inkjet head 11 while circulating the ink, without causing defect that ink hangs down from the nozzles and air is sucked.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as fall within the scope and spirit of the inventions.

What is claimed is:

1. An inkjet printer which causes ink to flow in a circulation path communicating from a downstream ink tank to an upstream ink tank, from the upstream ink tank to the downstream ink tank via an inkjet head, and is able to discharge ink from nozzles of the inkjet head, the ink jet printer comprising:
an ink temperature measuring unit adapted to measure an ink temperature in the upstream ink tank and the downstream ink tank;
an ink temperature adjustment portion adapted to gradually raise the ink temperature of the upstream ink tank and the downstream ink tank;
a circulation control unit adapted to circulate ink filling the circulation path in a room temperature state as it is for a planned time; and
an ink temperature control unit adapted to operate the ink temperature adjustment portion while circulating the ink after the planned time elapses, and raise the ink temperature of the upstream ink tank and the downstream ink tank up to a preset temperature.

2. The printer according to claim 1,
wherein the ink temperature adjustment portion is a water bath structure in which the upstream ink tank and the downstream ink tank are immersed in liquid, and the ink temperature is gradually raised by heating the liquid and heating ink in the upstream ink tank and the downstream ink tank via the liquid.

3. The printer according to claim 2,
wherein the ink temperature control unit raises the ink temperature of the upstream ink tank and the downstream ink tank up to a preset temperature within a range so as not to degrade ink characteristics.

4. The printer according to claim 3,
wherein the ink temperature adjustment portion is constituted by a first temperature adjustment portion in which the upstream ink tank is immersed, and a second temperature adjustment portion in which the downstream ink tank is immersed.

5. An ink circulating control method of an inkjet printer which causes ink to flow in a circulation path communicating from a downstream ink tank to an upstream ink tank, from the upstream ink tank to the downstream ink tank via an inkjet head, and is able to discharge ink from nozzles of the inkjet head, the method comprising:
circulating ink filling the circulation path in a room temperature state for a planned time; and
raising the ink temperature up to a preset temperature using ink temperature adjustment portions provided in the upstream ink tank and the downstream ink tank while circulating the ink after the planned time elapses.

6. The method according to claim 5,
wherein the ink temperature of the upstream ink tank and the downstream ink tank is gradually raised up to a preset temperature within a range so as not to degrade ink characteristics.

7. An ink circulating control method of an inkjet printer which causes ink to flow in a circulation path communicating from a downstream ink tank to an upstream ink tank, from the upstream ink tank to the downstream ink tank via an inkjet head, and is able to discharge ink from nozzles of the inkjet head, the method comprising:
circulating ink filling the circulation path in a room temperature state for a planned time;
raising the ink temperature up to a preset temperature using ink temperature adjustment portions provided in the upstream ink tank and the downstream ink tank while circulating the ink after the planned time elapses; and
raising the temperature in the inkjet head to a predetermined temperature by a heating portion provided in portions of an upstream side conduit line member from the upstream ink tank to the inkjet head and a downstream side conduit line member from the inkjet head to the downstream ink tank of the circulation path near the inkjet head, if the ink temperature of the upstream ink tank and the downstream ink tank reaches a predetermined temperature.

8. The method according to claim 5,
wherein the heating portion is controlled so that the ink temperature in the inkjet head becomes substantially the same as the ink temperature in the upstream ink tank and the downstream ink tank.

9. The method according to claim 6,
wherein the heating portion is constituted by a downstream side tube heater provided in the downstream side conduit line member and an upstream side tube heater provided in the upstream side conduit line member, and the downstream side tube heater is heated earlier than the upstream side tube heater.
